(19) United States
(12) Patent Application Publication
(10) Pub. No.: US 2012/0271523 A1
(43) Pub. Date: Oct. 25, 2012

(54) METHOD FOR OPERATING AN AUTOMATED PARKING BRAKE IN A MOTOR VEHICLE

(76) Inventor: Amir Ali Sardari Iravani, Besigheim (DE)

(21) Appl. No.: 13/504,878

(22) PCT Filed: Oct. 13, 2010
(86) PCT No.: PCT/EP2010/065329

§ 371 Date: Jul. 11, 2012

(30) Foreign Application Priority Data
Nov. 6, 2009 (DE) 10 2009 046 495.6

(51) Int. Cl. B60T 7/12

(52) U.S. Cl. 701/70

(57) ABSTRACT

In a method for operating an automated parking brake in a motor vehicle whose drive train includes a transmission and a clutch, an instantaneous clutch engagement point is ascertained during a driving operation of the motor vehicle and the presence of a starting request is checked when the parking brake is activated. If the presence of a starting request is detected, the activated parking brake is automatically released, the detection of the presence of a starting request taking place as a function of the ascertained clutch engagement point.

### BACKGROUND OF THE INVENTION

1. Field of the Invention

The present invention relates to a method and a control device for operating an automated parking brake.

2. Description of Related Art

Vehicles, in particular those which are driven by an internal combustion engine and are equipped with a manual or an automated transmission, are equipped with a parking brake for the purpose of permitting safer parking and facilitating starting on an uphill gradient. In recent times, parking brakes of this type have been replaced or supplemented by corresponding electromechanical systems. The braking action usually takes place on the rear wheels of the vehicle.

WO 2006/114423 A1 describes a method and a device for detecting a clutch slipping point, in which, among other things, a transmission ratio at the point in time of engaging the clutch is evaluated.

A method for operating a parking brake which is operable with the aid of external power is known from WO 2006/045841 A1.

### BRIEF SUMMARY OF THE INVENTION

The method according to the present invention has the advantage that an automated parking brake may be released when starting a vehicle on a hill or after having been parked, without being operated by the driver, in that one or more operating variables of the vehicle are ascertained and used to control the automated parking brake. The starting process may be improved by limiting or preventing the vehicle from starting against a parking brake which has not yet been unlocked. Even particularly rapid starting processes may be improved. The method requires only a comparatively small number of sensors and may essentially be carried out as a supplementary function of a computer program of a control and/or regulating device if the required sensors are already present in the vehicle.

The present invention is based on the consideration that a clutch engagement point, after which a fixed connection between a drive shaft and the drive train is no longer present, is reached during declutching. A torque which is sufficiently high for starting may be typically transferred from the engine to the driving wheels during engagement of the clutch when this clutch engagement point is reached or at a position of a clutch pedal corresponding thereto. According to the present invention, the reaching of this state of the clutch or this position of the clutch pedal during engagement marks the presence of a starting request and is a first partial aspect of the method described by the present invention. The presence of a starting request may be detected even more reliably by ascertaining or evaluating different variables of operating values of the vehicle.

The present invention advantageously takes into account the circumstance that the clutch engagement point shifts in relation to the position of the clutch pedal as a result of wear or aging. For this purpose, the instantaneous clutch engagement point is regularly or occasionally ascertained during the driving operation of the motor vehicle and stored in the control and/or regulating device. The instantaneous clutch engagement point is therefore “learned.” This is another aspect of the present invention. In this way, the automated parking brake may also be automatically released, i.e., unlocked, at an optimum point in time during starting, even if the clutch engagement point has changed due to wear. This affects starting in both the forward and reverse directions.

The present invention is also applicable to semi-automatic vehicle transmissions provided that these transmissions have a clutch and an actuator which corresponds to a clutch pedal to be operated by the driver and which may be used to operate the clutch. The presence of a starting request may then be derived from the instantaneous position of this actuator as well as from the instantaneous position of the clutch pedal.

A change in the engine speed is preferably monitored for ascertaining the clutch engagement point, starting from an engaged state of the clutch. If the change in the engine speed exceeds a predefinable threshold value, it is concluded that the clutch pedal has been operated and a fixed connection between the drive shaft and drive train no longer exists. The instantaneous position of the clutch pedal is then ascertained. This position thus corresponds to the point in time at which the change in the engine speed exceeds the predefinable threshold value. This is based on the consideration that only minor changes in the engine speed occur within a certain time interval in the engaged state of the clutch, i.e., the time derivative of the engine speed does not exceed a certain threshold. However, as soon as the driver operates the clutch pedal—usually for the purpose of changing gears—the time derivative of the engine speed may exceed this threshold. In general, the engine speed will increase comparatively quickly as a result of the sudden load relief. The instantaneous position of the clutch pedal is detected or read by a clutch pedal travel sensor coupled thereto at precisely this point in time and may thus be used for the clutch engagement point to be ascertained. The clutch engagement point therefore corresponds to the clutch position or the position of the clutch pedal at this point in time. The instantaneous clutch engagement point is therefore “learned.”

According to one preferred specific embodiment, the exceeding of the threshold for the time derivative of the engine speed is taken into account only if the accelerator pedal has not been operated or retracted by the driver to prevent a possibly distorting influence of the torque request transferred by the driver by operating the acceleration pedal.

Monitoring the change in the engine speed in the engaged state of the clutch and ascertaining an instantaneous position of the clutch pedal associated therewith permit a particularly accurate and simple ascertainment of the clutch engagement point. This procedure may be supplemented by mathematical operations, for example by forming a mean value of multiple instantaneous positions of the clutch pedal detected in this way to permit even more reliable determination of the clutch engagement point.

During the operation (depression) of the clutch pedal, the time derivative of the position of the clutch pedal is a value other than zero. This information may also be advantageously used to limit the previously designated point in time. To increase the efficiency of the method according to the present invention, it may be provided that the monitoring of the engine speed according to the present invention is to be carried out after the clutch pedal has been operated.

At least one of the following variables is preferably evaluated for detecting the presence of the starting request: the ascertained clutch engagement point, the instantaneous engine speed, the instantaneous position of the clutch pedal, a time derivative (gradient) of the instantaneous position of the clutch pedal, an idling speed of the engine, an uphill gradient of the roadway, an instantaneous position of the accelerator pedal, an instantaneously engaged gear of the vehicle transmission, an offset value. These variables are often easily and precisely detected, ascertained or derived in modern motor vehicles with the aid of existing sensors. For example, the positions of the accelerator pedal and the clutch pedal may be shown as percentage values. The uphill gradient of the roadway may be ascertained with the aid of a gradiometer, or an existing sensor for the longitudinal acceleration acting in the direction of travel may be used for this purpose.

The presence of a starting request is detected particularly safely if the engine speed is higher than the idling speed, the position of the accelerator pedal is above a threshold value, the engaged gear permits starting, and the clutch pedal has reached or exceeded a position which corresponds to a sum of the ascertained clutch engagement point and the offset value. For example, it may be provided that the engine speed has a value which is greater than the idling speed as a first partial condition, which implies that the engine is in operation. The position of the accelerator pedal in relation to a threshold value may also be queried, which makes it possible to determine the torque which may be transmitted by the engine. This makes it possible to ensure that this torque is sufficiently high for the particular starting operation. An item of information about the instantaneously engaged gear may also be used for detecting a possible starting request.

In one advantageous specific embodiment, it may be provided that the presence of a starting request is inferred only if the first gear or the reverse gear is engaged. However, it is also conceivable that the presence of a starting request is detected even if the second gear is engaged.

If an uphill gradient of the roadway is taken into account, the item of information about whether a forward gear or a reverse gear has been engaged may be used as a basis for deriving the sign which corresponds to the uphill gradient of the roadway in determining the point in time, at which the parking brake is to be released.

The position of the clutch pedal is particularly important, from which it must be ascertained whether the clutch has reached the ascertained clutch engagement point stored in the control and/or regulating device or has already exceeded the clutch engagement point in the direction of engagement of the clutch. An offset value which is selected, for example as a function of an instantaneous uphill gradient of the roadway, a load situation of the vehicle and/or a time derivative of the position of the clutch pedal may be used for this purpose in addition to the clutch engagement point. If one or multiple of the aforementioned partial conditions have been met, the starting request is detected and the parking brake is automatically released.

In addition, it is proposed that the threshold value with which the position of the accelerator pedal is compared be selected as a function of an instantaneous uphill gradient of the roadway and/or an instantaneous load situation. This is particularly advantageous when starting on a hill, since a sufficient engine torque must be available to prevent the vehicle from rolling downhill after the parking brake has been released. Furthermore, a torque signal which is already present in many vehicles may be used instead of the estimate or ascertainment of the engine torque as a function of the position of the accelerator pedal.

Moreover, the vehicle load or the presence or load of a trailer may also be taken into account. Selecting the threshold value in this way makes starting even safer, a starting “against” the parking brake simultaneously being reduced and a downhill rolling of the vehicle nevertheless being reliably prevented when starting on an uphill gradient.

The method is improved if the offset value—which is added to the ascertained clutch engagement point during the determination of the point in time at which the parking brake is to be automatically released—is formed by at least one of the following variables: on the one hand, by the instantaneous uphill gradient of the roadway and/or, on the other hand, by the time derivative of the instantaneous position of the clutch pedal. The offset value may be used to adapt the ascertained clutch engagement point to a situation which deviates from normal starting on a flat roadway. This advantageously makes it possible to ensure that a sufficient torque is present at the clutch when the parking brake is released. The method is adapted in a manner similar to the way a driver would use a manual parking brake. On a steep uphill gradient of the roadway, one would customarily slip the clutch to a greater extent and press the accelerator more firmly. Conversely, a sporty driver may want to start with a slightly slipping clutch.

It is additionally proposed that the offset value be formed by forming a first product by multiplying the uphill gradient of the roadway by a first parameter P1, by forming a second product by multiplying the time derivative of the instantaneous position of the clutch pedal by a second parameter P2 and by linking the two products with each other (for example by addition or subtraction). In this way, the offset value may advantageously take both situations into account simultaneously, namely starting on a hill as well as in the event of a sporty start. A sporty start on an uphill gradient would also be possible. This results in the following as a possible equation for the clutch pedal position from which the parking brake is to be released:

Release position=ascertained clutch engagement point+offset value, it being possible to determine the offset value as follows:

Offset value=Offset_{—}1−Offset_{—}2.

The values Offset_1 and Offset_2 may be ascertained as follows, for example:

Offset_{—}1=P1*(uphill gradient of the roadway in percent);

Offset_{—}2=P2*(time derivative of the instantaneous position of the clutch pedal).

P1 and P2 are applicable, empirically based parameters which have, for example, constant values and may be provided with a sign if necessary. In determining the offset value, it may also be provided to subtract the value Offset_1 from the value Offset_2. The specific sign of these values or the type of linkage in each case depends, among other things, on the direction in which the individual values are examined. For example, the uphill gradient of the roadway may be examined in the negative sense, and the instantaneous position of the clutch pedal may be described in the direction of engagement of the clutch or in the direction of disengagement of the clutch.

The method is further improved if first parameter P1 and second parameter P2 are selected as a function of the uphill gradient of the roadway and/or the time derivative of the instantaneous position of the clutch pedal. The advantage is that the variables “Offset_1” and “Offset_2” described above may thus be flexibly weighted as a function of the uphill gradient of the roadway and/or the time derivative of the instantaneous position of the clutch pedal.

A further embodiment of the present invention provides that parameters P1 and P2 or functions which describe parameters P1 and P2 are stored in a value table. In this way, parameters P1 and P2 are easily and quickly accessible without requiring time-consuming computation operations. This simplifies the method and makes it more economical.

The method according to the present invention may be more easily applied if the variables used for operating the automated parking brake are ascertained by scanning. In this way, the detection or ascertainment of the variables may be time- and value-quantized and processed in an existing computer-based control and/or regulating device. It is particularly advantageous that these variables are often already present in today's vehicle, and the method is implementable in the form of a computer program.

### BRIEF DESCRIPTION OF THE DRAWINGS

FIG. 1 shows a simplified schematic representation of a motor vehicle which has an automated parking brake.

FIG. 2 shows a timing diagram for ascertaining a clutch engagement point.

FIG. 3 shows a torque at a clutch as a function of a position of the clutch pedal.

FIG. 4 shows a flow chart for a sequence of the method.

### DETAILED DESCRIPTION OF THE INVENTION

The same reference numerals are used for functionally equivalent elements and variables in all figures, even in different specific embodiments.

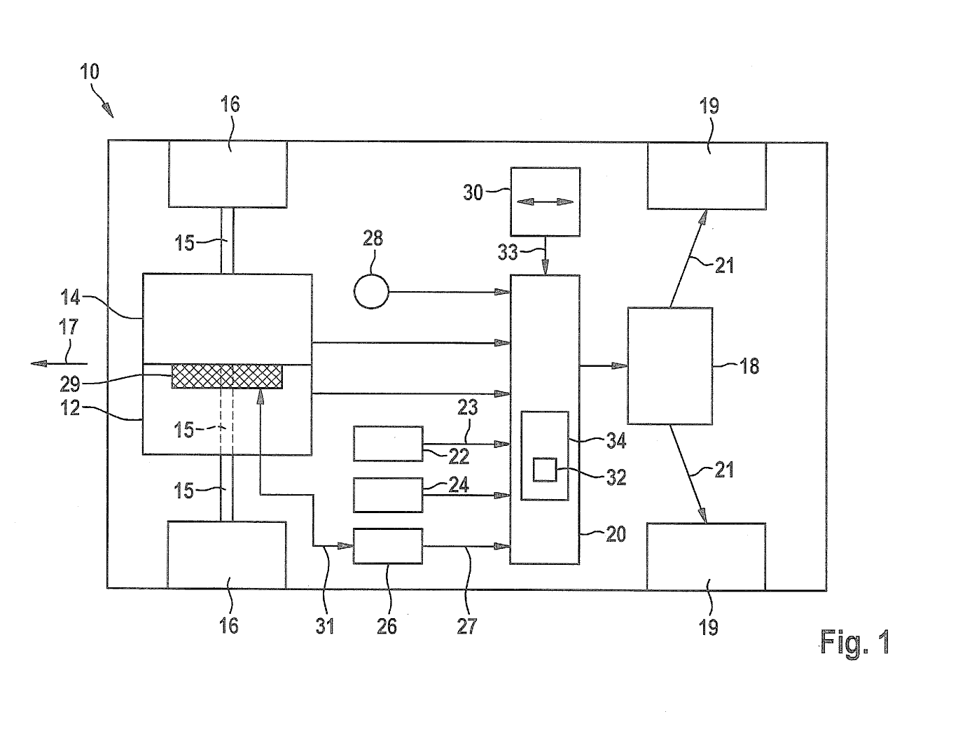

FIG. 1 shows a greatly simplified schematic representation of a motor vehicle, hereinafter referred to as a vehicle 10. A vehicle engine 12 is shown, which in the present case is an internal combustion engine and which drives two driving wheels 16 via a vehicle transmission 14 and two drive shafts 15. Vehicle transmission 14 is a manual transmission to be operated by the driver. Vehicle engine 12 is also referred to below as an engine 12. An arrow 17 identifies the forward travel direction of vehicle 10.

An automated parking brake 18 acts upon wheels 19, which is indicated by arrows 21. A control and/or regulating device 20 acts upon automated parking brake 18. An accelerator pedal 22, a position 23 of accelerator pedal 22, a brake pedal 24, a clutch pedal 26, a position 27 of clutch pedal 26 and a parking brake button 28 are illustrated, whose positions or states are ascertained by suitable sensors and supplied to control and/or regulating device 20. In the drawing in FIG. 1, this is illustrated by arrows (some of which have no reference numerals).

Clutch pedal 26 acts upon a clutch 29 which establishes a force-fit connection between engine 12 and vehicle transmission 14 in the engaged state. This is indicated by an arrow 31. A sensor 30 also transmits an instantaneous longitudinal acceleration 33 of vehicle 10 to control and/or regulating device 20. Control and/or regulating device 20 furthermore includes a storage medium 34, on which a computer program 32 is stored, computer program 32 being programmed to carry out the method according to the present invention when it is executed on control and/or regulating device 20. The storage medium is designed, in particular, as a magnetic or optical storage medium.

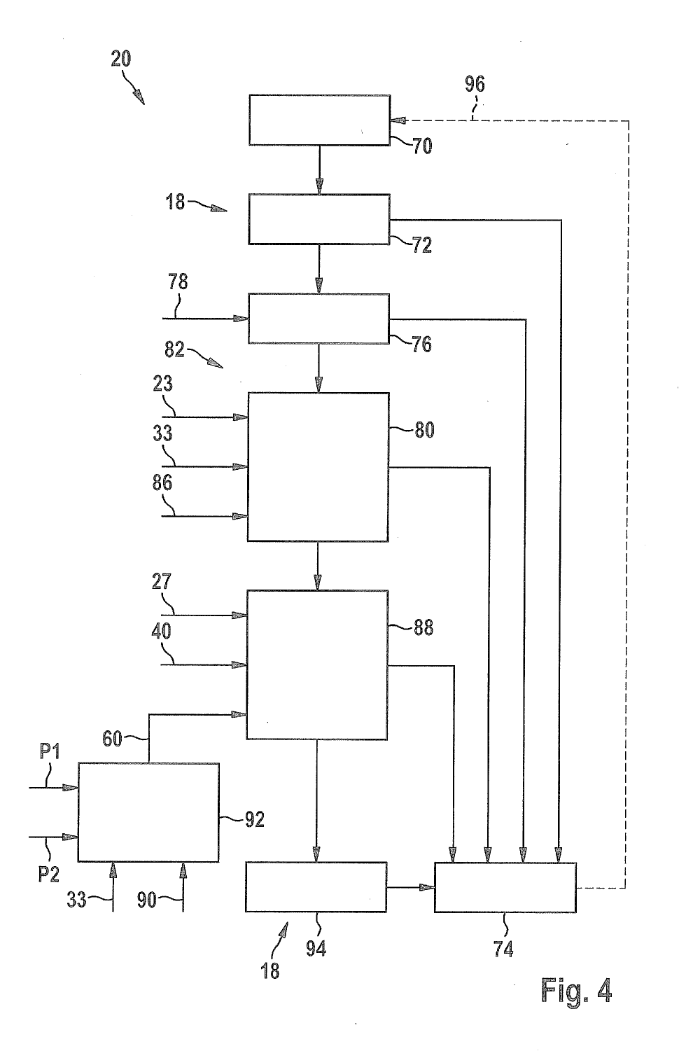

With the aid of the method according to the present invention, the parking brake button 28 does not need to be operated by the driver when starting vehicle 10 from a parked state, but instead automated parking brake 18 is automatically unlocked by control and/or regulating device 20. For this purpose, control and/or regulating device 20 ascertains the engine speed, the engaged gear of vehicle transmission 14 as well as position 23 of accelerator pedal 22 and position 27 of clutch pedal 26. Based on the ascertained variables for the engine speed and position 27 of clutch pedal 26, the changes thereof are also preferably ascertained, for example by the time derivatives (gradients) thereof. The engine speed is assigned reference numeral 78 below, as illustrated in FIG. 4.

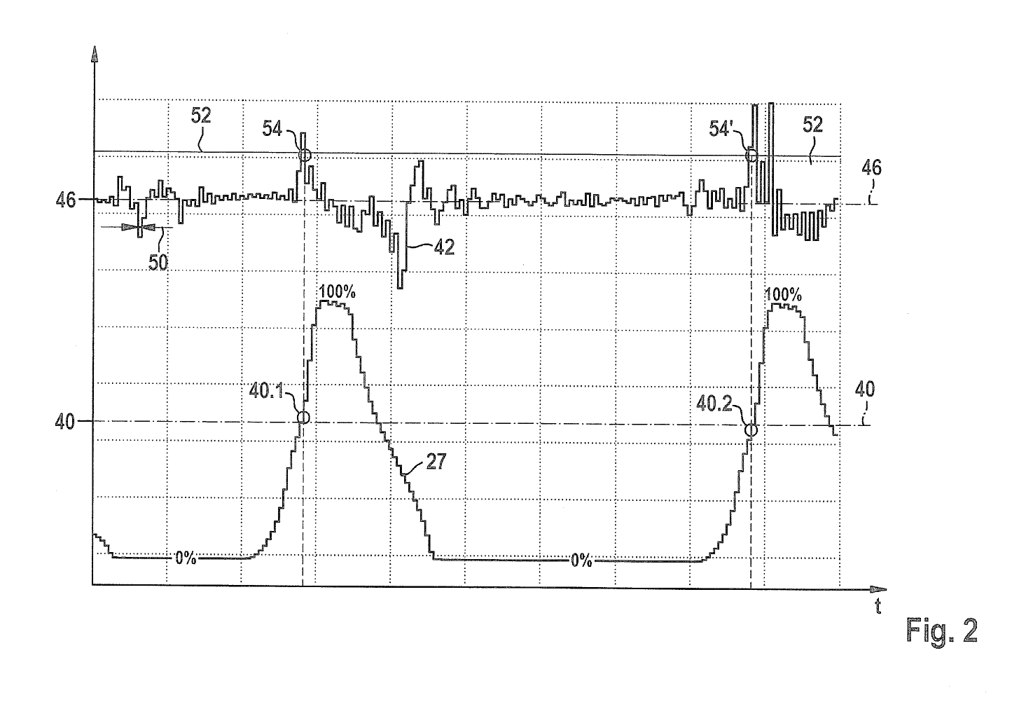

FIG. 2 shows a diagram for ascertaining an instantaneous clutch engagement point 40. A time progression of a time derivative 42 (gradient) of engine speed 78 is illustrated in the upper part of FIG. 2. A zero line 46 is illustrated only in areas for display reasons. A time progression of position 27 of clutch pedal 26 is illustrated in the lower part of FIG. 2. An indication “0%” characterizes a fully engaged state of clutch 29 and an indication “100%” characterizes a fully disengaged state of clutch 29. Both illustrated curves have an identical time scale “t” in relation to each other and are time-quantized with the aid of scanning step width 50. Scanning step width 50 in the present case is 20 milliseconds. Of course, other scanning step widths are conceivable.

An instantaneous clutch engagement point 40 is ascertained, or a previously ascertained, stored value of instantaneous clutch engagement point 40 is checked and, if necessary, adapted with the aid of multiple disengaging operations, which do not necessary have to be consecutive and which the driver carries out when shifting vehicle transmission 14 during normal vehicle operation. The ascertainment of the instantaneous clutch engagement point is carried out regularly or occasionally by control and/or regulating device 20 and is unnoticeable to the driver. A gradual clutch wear and other inaccuracies are taken into account hereby, so that an unlocking of automated parking brake 18 may be optimally carried out by control and/or regulating device 20 at any time after starting from the parked state or when starting on a hill, with the aid of the method according to the present invention.

When ascertaining instantaneous clutch engagement point 40, time derivative 42 of engine speed 78 is compared with a threshold value 52. At the same time, a time derivative (not illustrated) of position 27 of clutch pedal 26 is ascertained. The goal is to ascertain the transition from an engaged state to a disengaged state of the clutch as accurately as possible. It is required that the instantaneous clutch engagement point 40 ascertained in this way also be valid for the opposite situation of engagement. For this purpose, instantaneous position 27 of clutch pedal 26 is detected on the basis of an engaged state of clutch 29 the first time threshold value 52 is exceeded at points in time 54 and 54′ and simultaneously a positive time derivative of position 27 of clutch pedal 26. Clutch pedal 26 is thus operated by the driver for disengaging the clutch. The detected clutch pedal position is subsequently used as a contribution 40.1 and/or 40.2 for ascertaining instantaneous clutch engagement point 40. With the aid of multiple contributions of this type, a mean value is formed in control and/or regulating device 20, taking into account a previously ascertained and stored instantaneous clutch engagement point 40, and the mean value is stored, for example, in storage medium 34 or in another memory area of control and/or regulating device 20 as a new instantaneous clutch engagement point 40.

Use is made of the circumstance that engine speed 78 does not undergo any very rapid time changes in the engaged state of the clutch. Conversely, engine speed 78 may change comparatively quickly during a sudden load relief as a result of a disengagement of the clutch, so that threshold value 52 may be exceeded. Engine speed 78 thus generally increases.

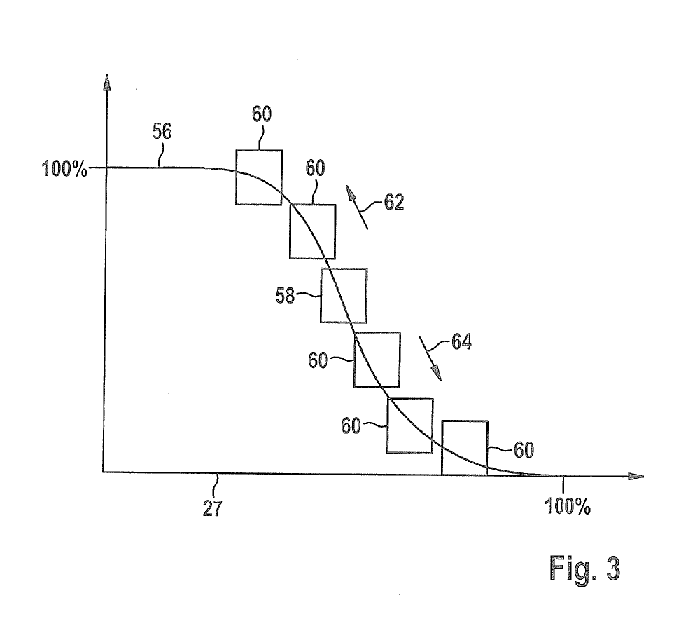

FIG. 3 shows a curve for a torque 56 over position 27 of clutch pedal 26. The points marked “100%” designate a maximum available torque 56 or a fully depressed clutch pedal 26. An area 58 approximately in the center of the curve illustrated in FIG. 3 designates an area of instantaneous clutch engagement point 40. On this basis, areas of offset values 60 are illustrated which may arise as a function of an operating situation of vehicle 10 or a behavior of the driver.

An arrow 62 points to areas for offset value 60, which result at steeper uphill gradient of the roadways. An arrow 64 points to areas for offset value 60 which preferably result at a sporty start of vehicle 10.

FIG. 4 shows a flow chart for unlocking automated parking brake 18 for processing in a control and/or regulating device 20 of a vehicle 10 according to one possible specific embodiment of the method according to the present invention. With reference to the drawing, the sequence essentially takes place from top to bottom. The illustrated procedure begins in a starting block 70. The state of automated parking brake 18 is queried in a block 72. If the brake is already unlocked, the procedure branches to an end block 74 and is thereby terminated. In a block 76, engine speed 78 is compared with an idling speed of engine 12. If engine speed 78 is less than the idling speed, the procedure branches to end block 74. In subsequent block 80, position 23 of accelerator pedal 22 is compared with a threshold value 82, which is formed from a longitudinal acceleration 33 and an engaged gear 86. The uphill gradient of the roadway in thus ascertained in the present case from longitudinal acceleration 33 without requiring a special gradiometer. The information about engaged gear 86 is also used to ascertain the starting direction (forward or reverse) and, if necessary, to exclude a gear which is unsuitable for starting. If position 23 of accelerator pedal 22 is less than threshold value 82, a sufficient starting torque is not yet present. If no sufficient starting torque is present continuously, it may be provided that the procedure branches to end block 74 and an automatic release of the parking brake does not take place. It may be provided, of course, that the driver releases the parking brake, for example, by operating a switch or button.

However, if a sufficient torque is present, the variables important for engaging the clutch are evaluated in a block 88. For this purpose, position 27 of clutch pedal 26, instantaneous clutch engagement point 40 and offset value 60 are evaluated in block 88. Offset value 60 is formed in a block 92 from an Offset_1, from which an Offset_2 is subtracted. Offset_1 is formed by the uphill gradient of the roadway ascertained from longitudinal acceleration 33, multiplied by a parameter P1, and Offset_2 is formed by a time derivative 90 of position 27 of clutch pedal 26, multiplied by a parameter P2. Block 88 evaluates whether position 27 of clutch pedal 26 has reached or exceeded instantaneous clutch engagement point 40, to which offset value 60 is added. If this is the case, automated parking brake 18 is deactivated, i.e. released (unlocked), in block 94. If this is not the case or not within a predefinable period of time, it may be provided that the procedure branches to end block 74. Once again, the driver may release the parking brake manually if he so desires.

The method sequence according to FIG. 4 may be repeated, as needed, directly at start block 70 after reaching end block 74, which is indicated by dashed line 96. Alternatively the procedure may be suspended for a shorter or longer time, or it may be called up again periodically from the control and/or regulating device 20.

The flow chart illustrated in FIG. 4 may be modified in many different ways. In particular, an execution of the method according to the present invention may provide that not all variables illustrated in FIG. 4 are detected or evaluated. Likewise, however, enhancements are also possible in such a way that additional information is detected and evaluated, for example, to permit a plausibility check of individual detected values or to implement a redundancy and thus increase the reliability of the method according to the present invention.

1-13. (canceled)

14. A method for operating an automated parking brake in a motor vehicle having a drive train which includes a transmission and a clutch, the method comprising:
ascertaining, during a driving operation of the motor vehicle, an instantaneous clutch engagement point during at least one disengagement operation of the clutch;
checking for the presence of a starting request if the parking brake is activated; and
in the case the presence of the starting request is detected, automatically releasing the activated parking brake, wherein the detection of the presence of the starting request takes place as a function of the ascertained instantaneous clutch engagement point.

15. The method as recited in claim 14, wherein the ascertainment of the instantaneous clutch engagement point includes:
monitoring a change in the engine speed in the engaged state of the clutch; and
ascertaining an instantaneous position of a clutch pedal which corresponds to the point in time at which the change in the engine speed exceeds a predefined threshold value.

16. The method as recited in claim 14, wherein at least one of the following variables is evaluated for detecting the presence of the starting request:
the ascertained instantaneous clutch engagement point;
the instantaneous engine speed;
the instantaneous position of a clutch pedal;
a time derivative of the instantaneous position of the clutch pedal;
an idling speed of the engine;
an uphill gradient of a roadway on which the vehicle is positioned;
an instantaneous position of an accelerator pedal;
a torque of the engine;
an instantaneously engaged gear of the vehicle transmission; and
a predetermined offset value.

17. The method as recited in claim 16, wherein the presence of the starting request is detected if:
the engine speed is higher than the idling speed;
the instantaneous position of the accelerator pedal is above a predetermined threshold value;
the engaged gear of the vehicle transmission permits starting; and
the clutch pedal has at least reached a position in the direction of engagement of the clutch which corresponds to a sum of the ascertained instantaneous clutch engagement point and the predetermined offset value.

18. The method as recited in claim 17, wherein the predetermined threshold value is selected as a function of at least one of the instantaneous uphill gradient of the roadway and an instantaneous load.

19. The method as recited in claim 17, wherein the offset value is formed by at least one of: (i) the instantaneous uphill gradient of the roadway; and (ii) the time derivative of the instantaneous position of the clutch pedal.

20. The method as recited in claim 19, wherein the offset value is formed by:
forming a first product by multiplying the uphill gradient of the roadway by a first parameter;
forming a second product by multiplying the time derivative of the instantaneous position of the clutch pedal by a second parameter; and
linking the first and second products with each other, by one of addition or subtraction.

21. The method as recited in claim 20, wherein the first parameter and the second parameter are each a function of at least one of the uphill gradient of the roadway and the time derivative of the instantaneous position of the clutch pedal.

22. The method as recited in claim 21, wherein one of (i) the first and second parameters are stored in a table, or (ii) functions which describe the first and second parameters are stored in a table.

23. A non-transitory computer-readable data storage medium storing a computer program having program codes which, when executed on a computer, performs a method for operating an automated parking brake in a motor vehicle having a drive train which includes a transmission and a clutch, the method comprising:
ascertaining, during a driving operation of the motor vehicle, an instantaneous clutch engagement point during at least one disengagement operation of the clutch;
checking for the presence of a starting request if the parking brake is activated; and
in the case the presence of the starting request is detected, automatically releasing the activated parking brake, wherein the detection of the presence of the starting request takes place as a function of the ascertained instantaneous clutch engagement point.

24. A control device of a motor vehicle for operating an automated parking brake in a motor vehicle having a drive train which includes a transmission and a clutch, comprising:
means for ascertaining, during a driving operation of the motor vehicle, an instantaneous clutch engagement point during at least one disengagement operation of the clutch;
means for checking for the presence of a starting request if the parking brake is activated; and
means for automatically releasing the activated parking brake, in the case the presence of the starting request is detected, wherein the detection of the presence of the starting request takes place as a function of the ascertained instantaneous clutch engagement point.
